(19) United States
(12) Patent Application Publication
(10) Pub. No.: US 2005/0014119 A1
(43) Pub. Date: Jan. 20, 2005

(54) Audio-video communication device for computer users

(76) Inventor: Sergei Vladislavovich Rudakov, Rostov-na-Donu (RU)

Correspondence Address: JACOBSON HOLMAN PLLC, 400 SEVENTH STREET N.W., SUITE 600, WASHINGTON, DC, 20004, US

(21) Appl. No.: 10/483,991

(22) PCT Filed: Jul. 12, 2002
(86) PCT No.: PCT/RU02/00335

(30) Foreign Application Priority Data
Jul. 23, 2001 (RU) 2001120276

(51) Int. Cl. G09B 3/00; G09B 5/00

(52) U.S. Cl. 434/350; 434/308

(57) ABSTRACT

The invention relates to gathering, processing and exchanging audio-video information with the aid of an audio-video communication between computer users and can be used for teaching and controlling the knowledge of trainable computer users, in particular for teaching a foreign language and informatics. Said invention enables the computer users to perform an audio and video communication therebetween and between the grouped computer users. The number of computer users who can be united into audio-video groups in random manner is not limited and depends on the number of connected audio and video switches. For example, 16 users can be get together for setting 8 audio groups and one video group with the aid of one audio switch and one video switch. The industrial multimedia linguaphone complex RINEL LINGO AUDIO-VIDEO makes it possible to connect 16 audio-video switches, provide with the communication 240 users and set 128 audio groups and 1 video group. Said Complex . . . is controlled with the aid of RINEL LINGO software.

### FIELD OF THE INVENTION

The invention relates to collecting, processing and interchange of the audio-video information, using the audio-video communication among computer users, and can be suitably used for training and knowledge-testing of the computer-user learners; for teaching foreign languages and informatics.

The invention enables the computer users to maintain the audio-video intercommunication, and allows to establish these types of communication among the computer users associated in a group.

### BACKGROUND OF THE INVENTION

Regarding the set of its essential features, the claimed invention's most pertinent art is “A complex for monitoring students' knowledge” according to RF Patent N 2001.204, 64/28, IPC G 09 B 7/07.

A disadvantage of said complex is its orientation to the applications for use with a certain group of learners and for use with pre-programmed reference replies.

Further, said complex does not allow to set up a group of learners who are trained using the audio-video communication, by discretion of a tutor.

### DISCLOSURE OF THE INVENTION

The object of the invention is to provide a multi-media training apparatus that would offer improved capabilities.

Said object is to be accomplished through an apparatus of the audio-video communication for computer users, comprising a central computer at the tutor's side provided with a software for organizing an educational process, and learners' computers coupled to said central computer via communication channels; which apparatus according to the invention comprises at least two audio cards, to each of which cards a microphone and headphones of computer users are connected; and at least two video cards; each one of said audio and video cards being inserted in ICA-, or PCI-slots in each of the computers; at least one video commutator, and at least one audio commutator that establish the audio-video communication between the computer users; the learners'computers and the tutor's central computer being connected—via the audio and video cards—respectively, to the audio commutator and video commutator; and the central computer—via a control channel—being connected, through control cables, to the audio commutator, and—via the audio commutator—to the video commutator; and using an appropriate program, said central computer controls formation and transformation of learner groups and performs sound-switching from the individual communication to the common loudspeaker communication.

The computer users (hereinafter—the users) encompassed by the audio communication are able to interconnect into audio groups arbitrarily, i.e. an audio group may comprise two and more users encompassed by the audio communication, and a particular user can be incorporated only in one group at a time. Members of one audio group are able to maintain the audio communication with one another, thereby not being a hindrance to members of another audio group. Thus a number of audio groups can be formed. The maximum number of users to be included into the audio communication, and the maximum number of audio groups that may be formed for them, will depend on a particular technical implementation (according to the embodiment described herein below, one audio commutator is capable of including into its communication up to 16 users and of forming up to 8 audio groups).

Connection and disconnection among the audio groups are controlled by one computer (for a computer-aided classroom this will be the tutor's computer).

When a user enters a group, he/she will hear in a headphones a mixed sound synthesized by his/her own computer, and the sound emitting from microphones and computers of other users of his/her audio group. Further, the “loudspeaker” communication is also provided, so that a user who has put his/her headphones off will be able hear a message.

The audio commutator has one or more ports (connectors), using which port a tutor can increase a number of users included into the audio communication by connecting identical audio commutators. According to the embodiment explained below, up to 16 audio commutators can be thus united, and the total number to be included into the audio communication can reach as much as 240 persons, and the number of audio groups—up to 128. The audio commutator also provides for a port (connector) to control the video commutator.

The users included into the communication can associate themselves in video groups arbitrarily (i.e. a video group may include one or more users included into the video communication, and a particular user can be a member of only one video group at a time) . In a video group, a screen image displayed in monitor of a user incorporated a given group can be transmitted to the monitor screens of all other users in this video group. The maximum number of users who can be included into the video communication, and the maximum number of the video groups that can be organized for them, depend on a particular technical embodiment (according to the embodiment explained below, up to 16 users can be included into the video communication using a single video commutator, and for whom one video group an be organized).

Connection and disconnection of video groups are controlled by a single computer (which is the tutor's computer—in a computer-aided classroom).

A tutor is able to increase a number of the users included into the video communication by way of connecting several video commutators. According to the embodiment explained below, up to 16 video commutators can be united, and the total number of the users to be included by the video communication can be as much as 240 persons, the video group remaining only one.

The control information composition, wherewith the audio commutators and video commutators are controlled, comprises a special information that determines a particular device (in respect of its type and serial number), to which the sequent control information pertains. Device types can be as follows: audio commutators, video commutators and other devices.

### BRIEF DESCRIPTION OF THE DRAWINGS

The invention further is explained by description of embodiments thereof, with reference to the accompanying drawings, in which drawings:

FIG. 1 shows a general block diagram of an audio communication device for computer users, according to the invention;

FIG. 2 shows a diagram for connecting a computer via an audio card—LINGO-card (a LINGO-card is to be inserted in PCI-, or ISA-slot of a computer);

FIG. 3 shows a general view of the LINGO-video card plane to be inserted in PCI- or ISA-slots in a computer;

FIG. 4 shows a scheme of interconnections among audio commutators and video commutators for increasing a number of the users included into the audio and video communication;

FIG. 5 shows a block diagram of an audio card;

FIG. 6 shows a block diagram of an audio commutator;

FIG. 7 shows a block diagram of a video card;

FIG. 8 shows a block diagram of a video commutator;

FIG. 9 shows a block diagram of a video card, wherein used is one channel for transmitting the video signal from a computer to a video commutator, and from the video commutator to the computer;

FIG. 10a shows a block diagram of a video commutator, using one channel for transmitting the video signal from a computer to a video commutator, and from a video commutator to a computer;

FIG. 10b shows a block diagram of a video commutator implemented as a passive mixer;

FIG. 10c shows a block diagram, wherein a monophonic channel is used;

FIG. 11a-11d show a block-diagram of a user circuit board;

FIG. 12a-12c show a block-diagram of an audio card (LINGO-card);

FIG. 13a-13f show a block diagram of a mother board.

### THE PREFERRED EMBODIMENT OF THE INVENTION

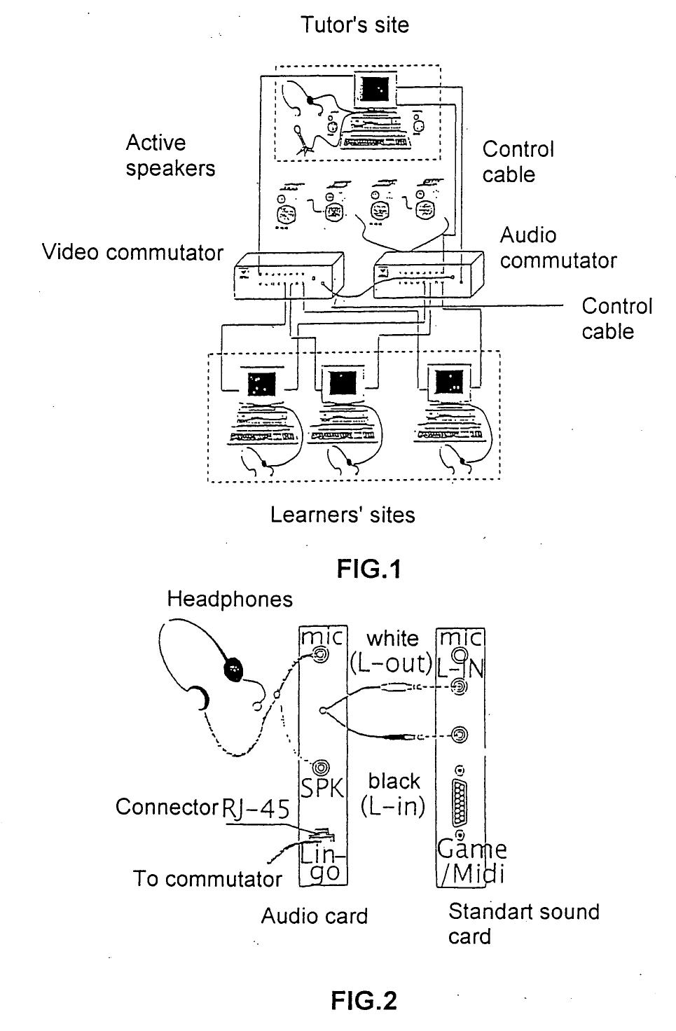

FIG. 1 shows a general diagram of an audio-video communication apparatus for computer users.

The apparatus includes an audio commutator and audio cards (one card per computer).

An audio commutator includes a housing, one mother board and user boards (1-8).

FIG. 2 shows a general diagram for connecting a computer via an audio card (an audio card is inserted in PCI-, or ISA-slot in a computer).

When an audio card is provided with L-OUT socket (a linear output), then the black connector (L-IN) of the jumper should be connected to said socket (FIG. 2). If L-OUT socket is not provided, the jumper black connector should be connected to SPK socket.

Inputs and outputs, termed as MIK, SPK, LINGO, L-IN, L-OUT on an audio card, can be implemented in various ways.

Using a video card, each of the computers can be connected, so that to:
avoid the presence of the input signal in the output signal, i.e. avoid any hard-to-manage feedbacks. Meant are the input and output signals that convey the sound from a user site to an audio commutator and vice versa (LINGO connector on an audio card: FIG. 2). Signals intermingle only at the output, whereat headphones are connected;
ensure an high-quality and parameter-uniform microphone input at all user sites;
significantly simplify the acoustic tuning and improve steadiness of system functioning, which is important for operation of a computer-aided classroom.

The apparatus also comprises a video commutator and video cards (one card per computer).

A video commutator includes a housing, mother board and subscriber circuit boards (1-8).

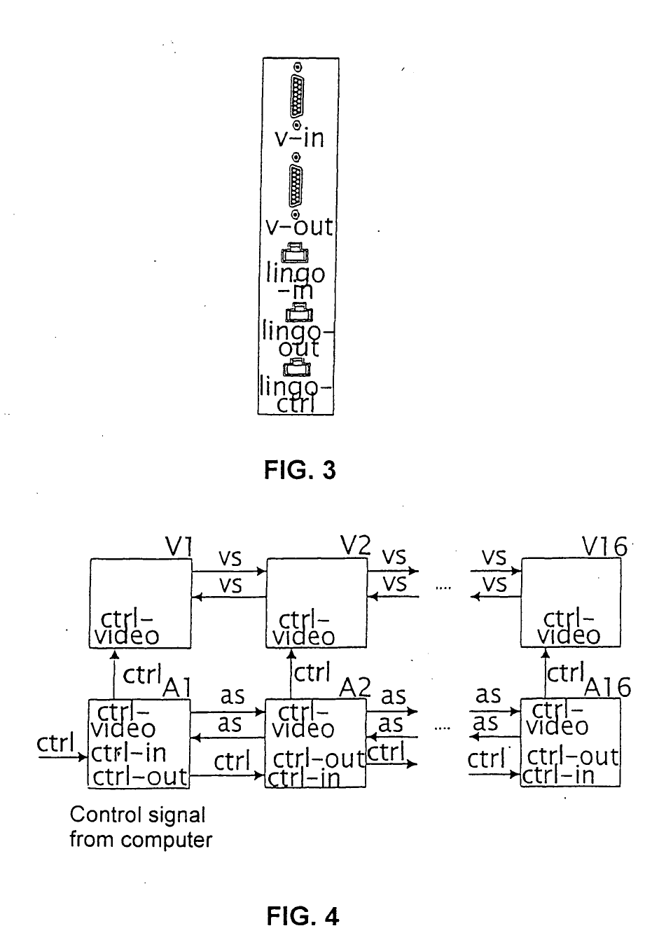

FIG. 3 shows a general view of the video card plane (the video card is inserted in PCI-, or ISA-slot in a computer).

V-IN connector is connected to the computer video card output. A computer monitor is connected to V-OUT connector. A video signal arrives at the video commutator from the computer via LINGO-OUT connector. A video signal arrives at the computer from the video commutator via LINGO-IN connector. The control signal arrives from the audio commutator, or directly from the computer through LINGO-CTRL connector. Said control signal transfers the video card into one of the two possible operation states: in the first operation state, a video signal, arriving from the computer video card at the V-IN connector, is supplied to V-OUT connector and LINGO-OUT connector; in the second operation state, the video signal, arriving from the video commutator via LINGO-IN connector, is supplied to V-OUT connector.

Connectors LINGO-CTRL, LINGO-IN, LINGO-OUT (abbreviated respectively as L-CTRL, L-IN, L-OUT) can be implemented in various ways as a single connector.

A manner for interconnecting the audio commutators and video commutators for the purpose to increase a number of operators included into the audio and video communication, is illustrated in FIG. 4.

FIG. 4 shows audio commutators A1, A2, A16; video commutators V1, V2, . . . V16.

Further, indices ctrl, as, vs respectively denote a control signal, audio signal and video signal.

Audio commutators are interconnected through the control channel and audio channel.

Audio commutators are interconnected in series through the control channel in a manner that the control signal proceeds from the controlling computer, tutor's central computer to a first audio commutator (to CTRL-IN connector), and is further transmitted from a first audio commutator to a second audio commutator (from CTRL-OUT connector to CTRL-IN connector) (FIG. 4). The control signal from the second audio commutator to a third audio commutator, from the third one to a fourth one, etc., is transmitted similarly to transmission of the control signal from the first audio commutator to the second one. The ctrl control signal is devised to include a special information that determines a particular audio commutator, to which the sequent control information will pertain, such that each one of the interconnected audio commutators could be controlled.

The audio commutators, via the audio channel, are interconnected through the same audio inputs and audio outputs, to which the audio cards are connected. Only the coupled audio inputs and audio outputs on one audio commutator can be used, i.e. the audio input must coincide with that of the audio output. For instance, on audio commutator N1 selected is audio input N3 and audio output N3; and on audio commutator N2 selected is audio input N5 and audio output N5. In this case: audio input N3 and audio output N3 on audio commutator N1 are respectively connected to audio output N5 and audio input N5 on audio commutator N2.

As the audio commutators allow to form audio groups, then one common audio group can be formed for the audio commutators interconnected in the manner discussed above, and thus the users connected to such audio group and concurrently connected to various audio commutators, can establish the audio communication among one another.

By increasing a number of connections, through audio channels, between the audio commutators, a number of the audio groups being common to said audio commutators can be increased, but in real practice one common audio group will suffice.

The claimed apparatus can be embodied to connect up to 16 audio commutators.

In the video commutator, the ctrl control signal arrives at CTRL-IN connector from CTRL-VIDEO audio commutator. When several interconnected audio commutators are used, video commutators are connected through the control channel to each corresponding audio commutator. The control signal is devised to comprise a special information that determines a particular video commutator, to which the sequent control information will pertain. The control signal setup also includes a special information that determines a particular commutator type (an audio commutator, or a video commutator), to which the sequent control information pertains.

Video commutators are interconnected through the video channel in series similarly to the manner, in which the audio commutators are connected through the audio channel. Audio commutators are interconnected through the video channel via the same video inputs and video outputs, to which the video cards are connected. Only the coupled video inputs and video outputs on one video commutator can be used, i.e. the video input must coincide with that of the video output. For instance, on video commutator N1 selected is video input N4 and video output N4; and on video commutator N2 selected is video input N6 and video output N6. In this case: video input N4 and video output N4 on video commutator N1 are respectively connected to video output N6 and video input N6 on video commutator N2.

As the video commutators allow to form video groups, then one common video group can be formed for the video commutators interconnected in the manner discussed above, and thus the users connected to such video group and concurrently connected to various video commutators, can establish the video communication among one another.

The video commutators are enabled to be interconnected in the quantity up to 16 video commutators.

The proposed manner for interconnecting the audio commutators and video commutators can be modified. It is important that the ctrl control signal would arrive at each one of the audio commutators and video commutators, that the audio commutators would be connected through the audio channel, and video commutators will be connected via the video channel. For example, several audio commutators can be connected to one audio commutator via the audio channel; and several video commutators can be connected to one video commutator via the video channel.

Using the above-discussed block-diagrams, an audio-video commutator combining both an audio commutator and video commutator, can be realized; and a single video card can combine an audio card with video card.

An audio commutator can be used as an independent system without a video commutator; and in this case the video communication may be not used, or said communication might be carried out with other techniques, for example—in software using the standard computer data transfer networks (implemented by RINEL company in RINEL-LIGO software).

A video commutator also can be used as an independent system, without an audio commutator, and in this case the audio communication may not be used, or said audio communication might be realized by other techniques, for example—in software using any standard data transfer computer networks.

The above-described block diagrams describe a particular embodiment for 16 users related to one commutator, wherein up to 16 commutator can be interconnected. But the invention described in said block diagrams can be applied for carrying out audio and video commutators for different number of users (less or more than 16) for various numbers of audio groups (less or more than 8), for different number of video groups (more than one), and for various number of possible interconnections of audio and video commutators (less or more than 16).

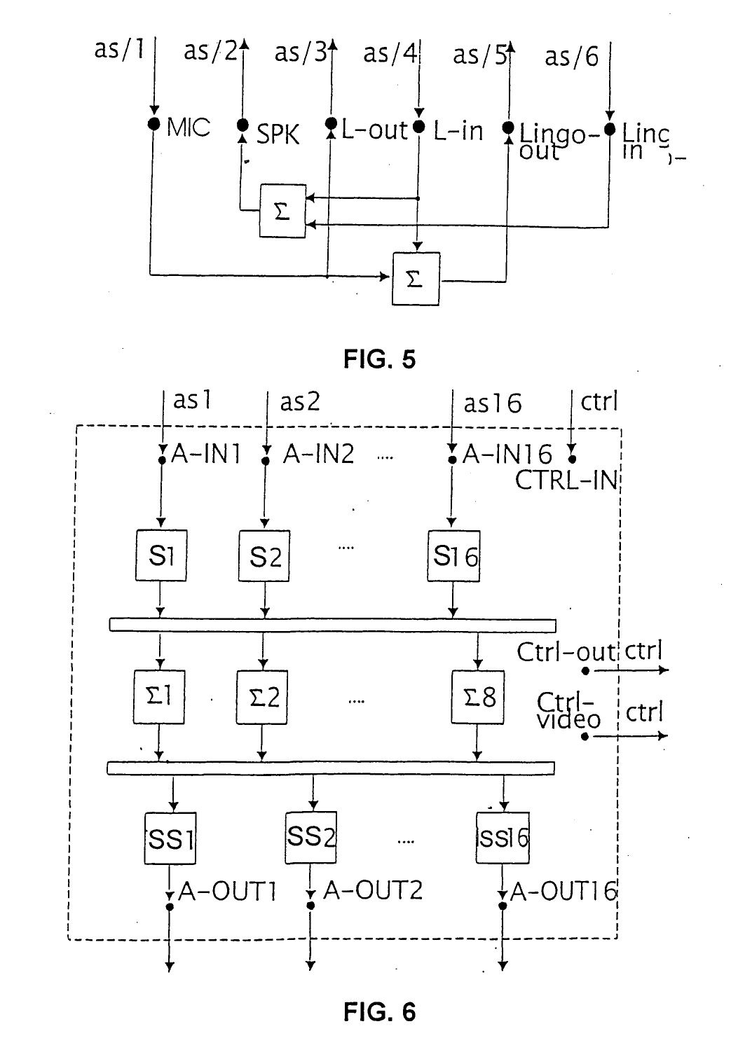

FIG. 5 shows a block diagram of a video card. In FIG. 5 indices as/1, as/2, . . . as/4 denote the audio signals. A method for transmitting the audio signal depends on a particular embodiment, which can be a standard, or non-standard, a specially developed method.

Connectors MIC, SPK, L-OUT, L-IN, LINGO-OUT, LINGO-IN can be implemented in various ways, for example connectors LINGO-OUT, LINGO-IN can be implemented as single connector RJ45 (marked as LINGO).

The following connectors are used:
MIC is the connector for connecting the operator's microphone;
SPK is the connector for connecting the operator's headphones;
L-IN is the connector for connection to the computer audio outputs L-OUT or SPK.
L-OUT is the connector for connection to the computer audio input L-IN.
LINGO-OUT is the connector for connection to the audio commutator audio input.
LINGO-IN is the connector for connection to audio output of audio commutator.

Further, the audio card uses summer Σ intended for mixing the input signals into single output signal.

The operator's headphones obtain the mixed signal from connectors L-IN and LINGO-IN. Output LINGO-OUT obtains the mixed signal from connectors MIC and L-IN. The audio signal from the microphone also arrives at connector L-OUT. In realization of the above-mentioned block diagram in a particular device, the implementation quality is of a great importance, and of a special importance is the quality of realization of the microphone input and the circuit for transmitting the audio signal from the microphone input.

FIG. 6 shows the block diagram of RINEL-LINGO AUDIO audio commutator.

In FIG. 6, indices as1, as2, . . . as16 denote the audio signals from computers from connectors LINGO-OUT of the corresponding audio cards.

Audio signals from connectors LINGO-OUT of the corresponding audio cards are sent to connectors A-IN1, A-IN . . . A-IN16.

Audio signals to connectors LINGO-IN of the corresponding audio cards are sent from connectors A-OUT1, A-OUT2, . . . A-OUT16.

The ctrl control signal is sent to connector CTRL-IN from the controlling computer; and using the ctrl control signal the audio commutator is entirely controlled.

Index CTRL-OUT denotes the connector for connecting an identical audio commutator. The ctrl signal is transmitted to another audio commutator via said connector.

Index CTRL-VIDEO denotes the connector for connecting a video commutator. The ctrl control signal is transmitted to the video commutator via said connector.

Summers Σ1, Σ2, . . . Σ8 mix all audio signals arriving at the summers, and the mixed signal is supplied to the summers' outputs.

Using switches S1, S2, . . . ,S16: audio signals as1, as2, . . . , as16 are sent to any of summers Σ1, Σ2, . . . Σ8 and at that, any of these audio signals can be directed only to one of the summers or may not be sent to any of the summers.

One mixed audio signal sas is picked off each of the summers, and accordingly signal sas1 is picked off summer Σ1, signal sas2 is picked off summer Σ2, etc.

Using switches SS1, SS2, . . . SS16: audio signals sas1, sas2, . . . sas8 are selectively sent to connectors A-OUT1, A-OUT2, . . . A-OUT16. Said selection is performed such that a certain audio signal sas is sent to particular connector A-OUT, when said signal sas comprises the audio signal “as” having the number that corresponds to that of connector A-OUT. For example, the mixed audio signal sas1 has been obtained by mixing the audio signals as4, as5, as7; and in this case audio signal sas1 is sent to connectors A-OUT4, A-OUT5, A-OUT7. All switchings in the audio commutator are controlled by the ctrl control signal.

Embodiments of said block diagrams in a particular apparatus can use various noise suppressors. The block diagrams shown herein do not indicate these noise suppressors.

The block diagrams shown in FIG. 5 and FIG. 6 are designed for 16 users and 8 audio groups, which is a particular version for embodying such block diagram in the claimed apparatus, but the same block diagrams are also valid for another number of the connectors for connecting operators A-IN, A-OUT and for another number of audio groups (which is determined by a number of Σ summers), i.e. the invention essence is not altered by a number of the implemented user-connection channels in a particular embodiment (in this case, the number of 16 in the block diagram. can be modified to any number being lesser or greater than 16), nor by a number of the implemented audio groups (a number of summers can be less or greater than 8).

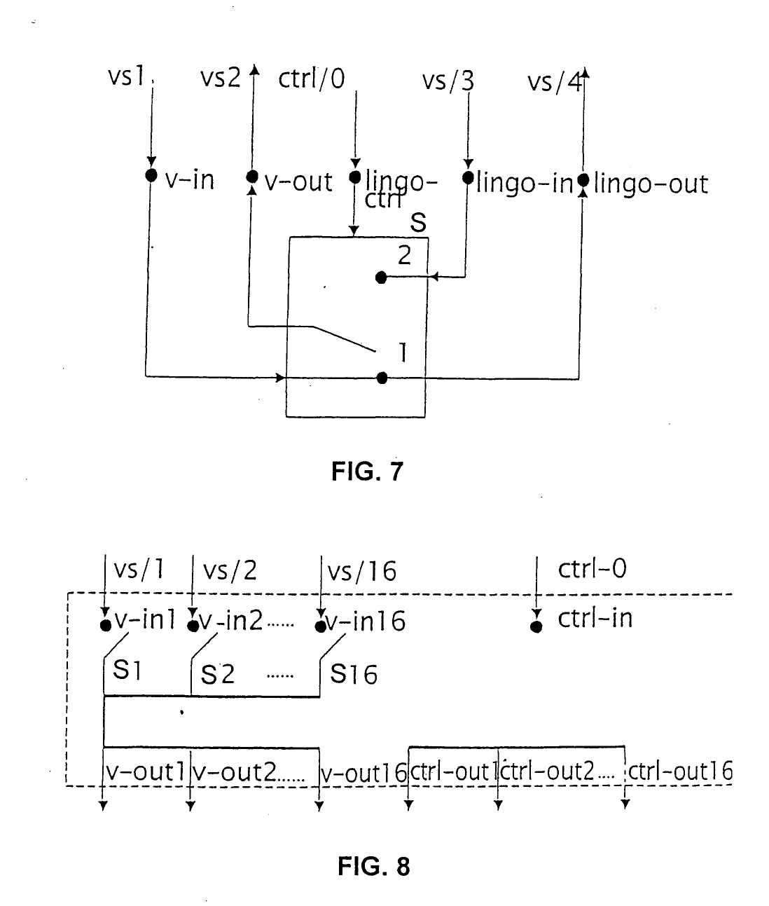

FIG. 7 shows a block diagram for a video card. In FIG. 7, indices va/1, vs/2 . . . vs/4 denote the video signals. A video signal transmission method depends on a particular embodiment version, which can be a standard one (RGB, video, etc.), or a non-standard method of a special design.

Index ctrl/0 denotes the control signal.

Connector V-IN is connected to the computer video card output. A computer monitor is coupled to connector V-OUT. A video commutator is connected via connector LINGO-IN, and the video signal from the video commutator is supplied to a computer through said connector. The video commutator is connected through connector LINGO-OUT, and the video signal from a computer to the video commutator is supplied through said connector.

The control signal from the video commutator is supplied via connector LINGO-CTRL. Said control signal transfers a video card (by switching the <<S>> switch) into one of two possible operation states: in the first (indicated by reference numeral 1 in the block diagram) operation state, the video signal sent from the computer video card to connector V-IN, arrives at connector V-OUT and connector LINGO-OUT; and in the second (indicated by reference numeral 2 in the block diagram) operation state, the video signal from the video commutator arrives at connector V-OUT via connector LINGO-IN. When any control signal is not supplied to connector LINGO-CTRL, the switch is in the first state.

FIG. 8 shows a block diagram of a video commutator.

In FIG. 8, indices vs1, vs2, . . . vsl6 indicate the computers' video signals sent from connectors LINGO-OUT of the corresponding video cards.

Video signals from connectors LINGO-OUT of the corresponding video cards are delivered to connectors V-IN1, V-IN2, . . . V-IN16.

From connectors V-OUT1, V-OUT2, . . . V-OUT16, the video signals are supplied to connectors LINGO-IN of the corresponding video cards.

From connectors CTRL-OUT1, CTRL-OUT21, . . . CTRL-OUT16, the control signals are supplied to connectors LINGO-CTRL of the corresponding video cards.

The ctrl control signal that entirely controls the video commutator arrives at connector CTRL-IN.

Among switches S1 . . . S16, only one switch can be closed, and all remaining switches should be open, i.e. at any given moment the video signal is transmitted only from one computer. By selecting an operation mode of switches S1 . . . S16 and switches S on the video cards, any required system configuration can be achieved. All switchings are controlled with the ctrl control signal via connector CTRL-IN.

A switching order (all switching operations being instructed by the control signal via connector CTRL-IN) may be as follows:
all video cards are transferred into state N1;
all switches S1 . . . S16 are opened;
one of switches S1 . . . S16 is closed;
the selected video cards are transferred into state N2.

The block diagrams according to FIG. 7 and FIG. 8 allow to embody various versions for switching the video signal, but in real practice there is no necessity of simultaneous transmission of the video signal from a computer to a the video commutator, and from the video commutator to the computer; in this case, for transmitting the video signal from the computer to the video commutator, and from the video commutator to the computer—only one video signal transmission channel can be used.

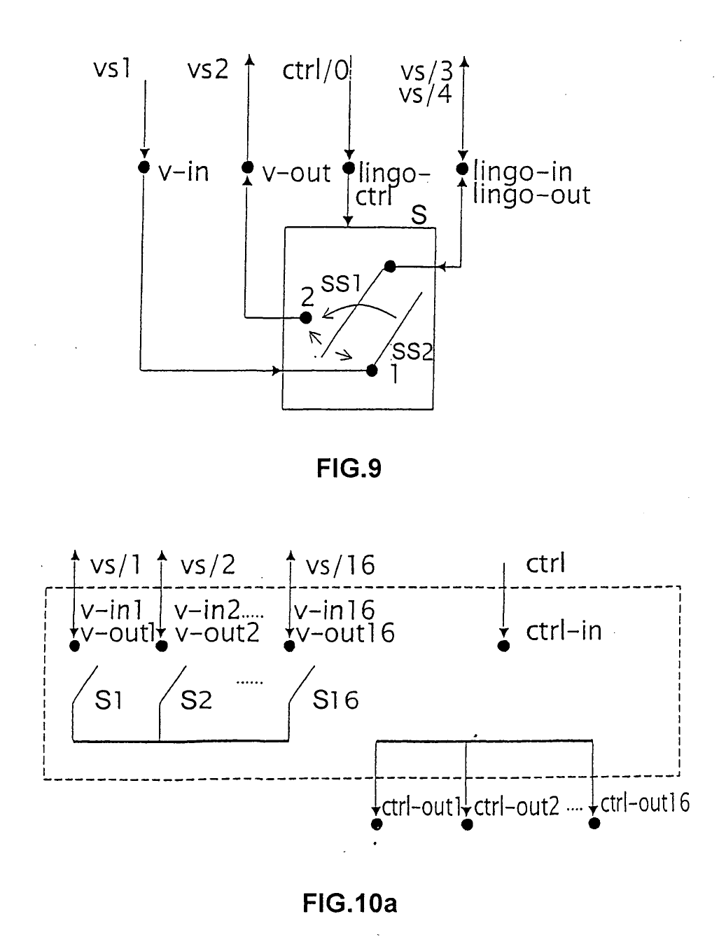

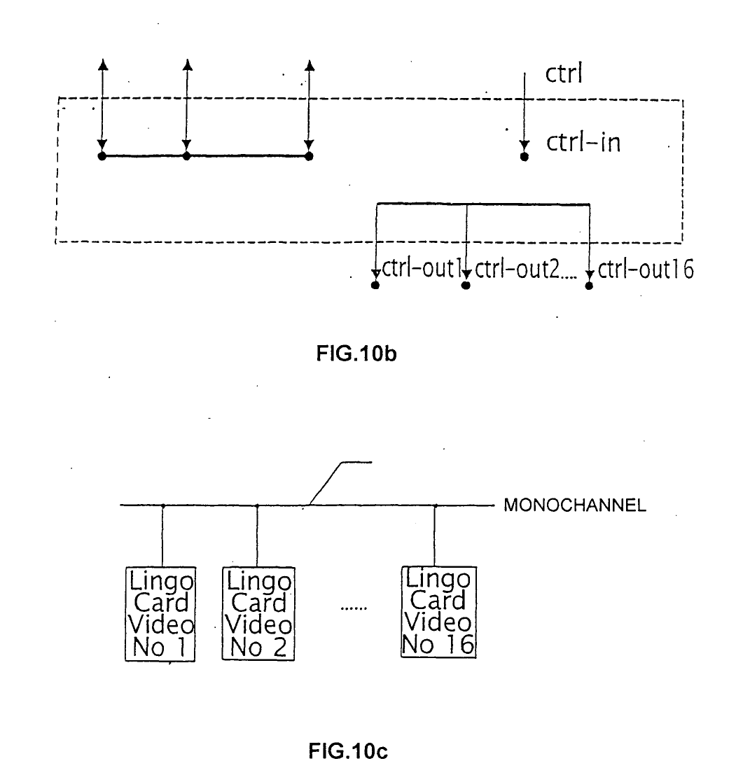

The block diagrams that use a single video signal transmission channel from a computer to a video commutator, and from the video commutator to the computer, are shown in FIG. 9 and FIGS. 10a, 10b, 10c.

FIG. 9 shows a block diagram for a video card, using a single video signal transmission channel from a computer to a video commutator, and from the video commutator to the computer.

FIG. 10a shows a block diagram of a video commutator, using a single video signal transmission channel from a computer to a video commutator, and from the video commutator to the computer.

Functionality of the block diagrams shown in FIG. 9 and FIG. 10 is distinct over those shown in FIG. 7 and FIG. 8 in respect of the following points.

A video card can be in two states.

1. In state N1, switch SS1 closes into position 1, and switch SS2 closes into position 2. In this state, the video signal from a computer video card is sent to the monitor of the same computer and to a video commutator. The video card is also in the N1 state, when the control signal LINGO-CTRL is absent.

2. In the N2 state, switch SS1 closes into position 2, and switch SS2 is in the open state. In this state, the video signal from the video commutator arrives at the computer monitor.

At that, inputs and outputs for video signals are combined: connectors V-IN1, V-IN2 . . . V-IN16 are respectively combined with connectors V-OUT1, V-OUT2 . . . V-OUT16, and a switching order can be as follows:
a) all switches S1 . . . S16 are open;
b) video cards of the user computers are transferred to a required state (N1 or N2);
c) the switches selected among S1, S2 . . . S16 are closed.

Number of switches must correspond to those of the user computers comprised by one group. Among the selected user computers, only one of them must be transmitting the video signal (this computer's video card must be in state N1); and all remaining user computers comprised by such group must receive the video signal (these computers' video cards must be in state N2).

Except for the above-mentioned distinctions, specification of functionality of the block diagrams shown in FIG. 9 and FIG. 10a does not differ from that of the block diagrams shown in FIG. 7 and FIG. 8.

When only one video group is required, in the video commutator arrangement any switches can be dispensed with (i.e., in this case, the video commutator is a passive mixer, the block diagram is shown in FIG. 10b). Besides, a monophonic channel can be used as the video signal transmission medium, and in such circumstance a video commutator becomes unnecessary (the block diagram that uses a monophonic channel is shown in FIG. 10c). This feature becomes possible owing to the possibility that in the case when only one video group is present, the video signal has to be transmitted only from one user computer at a time.

For a video commutator having no switches, and for the version of the claimed apparatus that does not use the video commutator (using the monophonic channel): the video card according to the block diagram shown in FIG. 9 can be used. In this case, VIDEO-LINGO card must operate in the following three modes.

1. Switch SS2 is closed to contact 2. Switch SS1 is open. In this state, video signal vs/1 arrives at the monitor of the same computer from the computer video card.

2. Switch SS2 is closed to contact 2, switch SS1 is closed to contact 1.

In this state, video signal vs/1 from the computer video card arrives at the monitor of the same computer and enters the video signal transmission channel via connector LINGO-IN, LINGO-OUT.

3. Switch SS1 is closed to contact 2, switch SS2 is open. In this state, the external video signal from connectors LINGO-IN, LINGO-OUT enters the computer monitor.

When switch SS2 closes to contact 1, it should be checked whether the video signal transmission channel is unoccupied. When SS2 is to be closed to contact 2, it should be ascertained that switch SS2 is open and the electric compatibility of the incoming video signal with the video monitor circuits has been attained.

Transmission of the ctrl/0 signal to a video card can be carried out by a method other than the above-discussed one: the control signal can arrive at the video card via the computer bus (PCI, ISA, etc.) wherein a video card has been inserted.

The block diagrams shown in FIGS. 7, 8, 9, 10a, 10b, 10c are designed for 16 users, which is a particular version of embodiment of said block diagrams in the claimed apparatus, but the same block diagrams can be used for a different number of the user-connection channels, i.e. the invention essence remains unaltered irrespective of a changing number of the implemented user-connection channels in any embodiment (in this case the number 16 in the block diagrams can be changed to any number being lesser or greater than 16).

Circuit diagrams of the claimed apparatus are discussed, and their operation is described below.

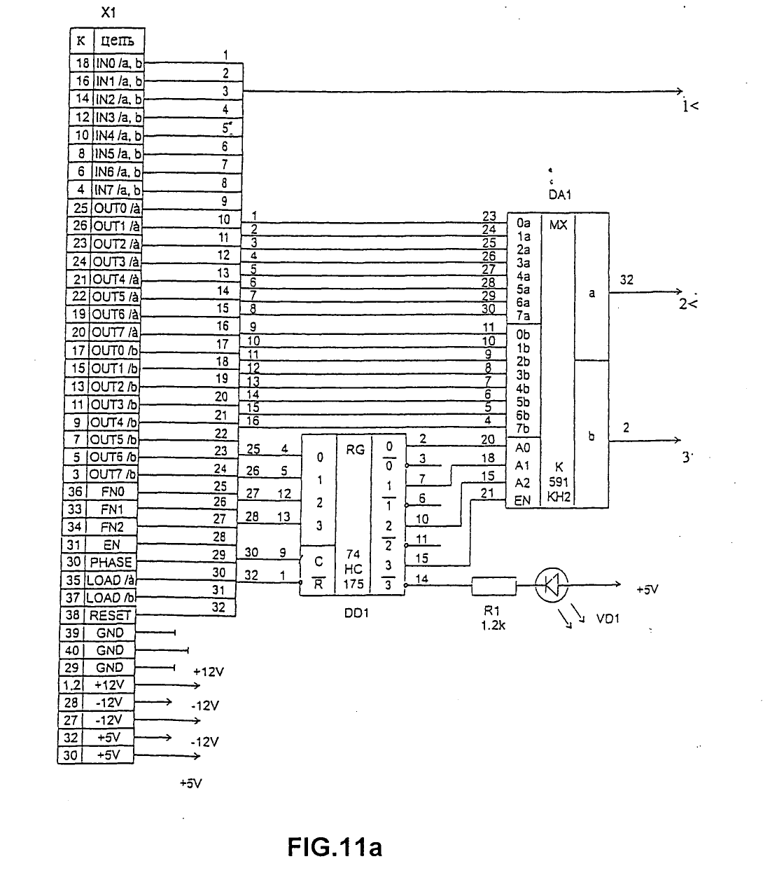

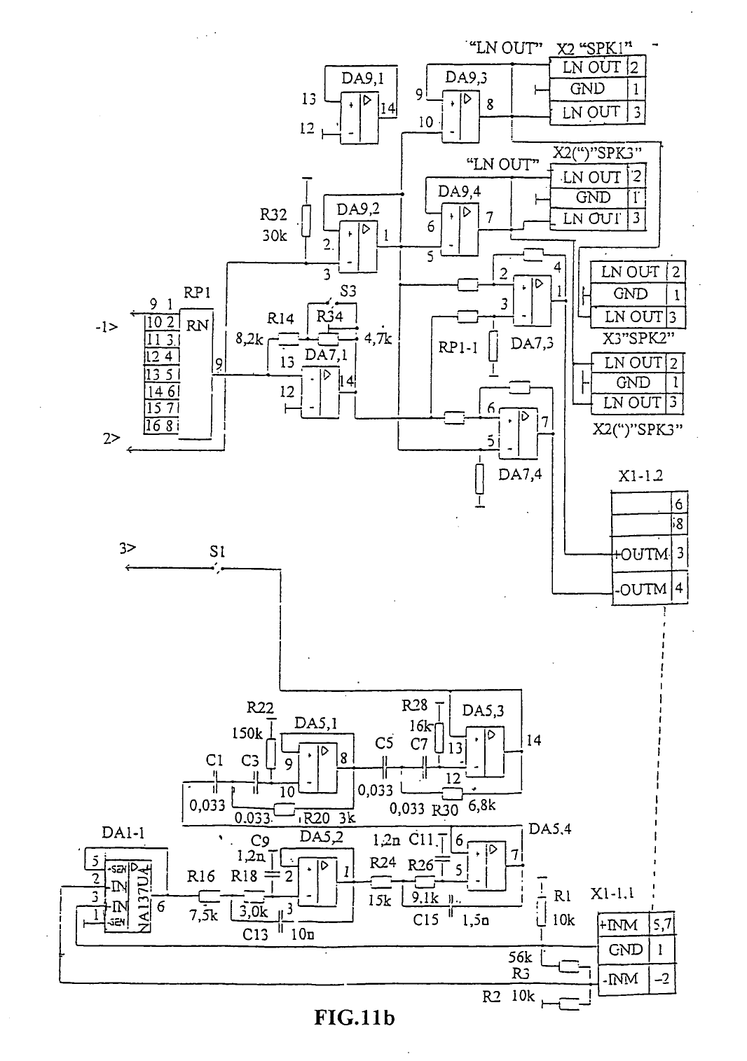

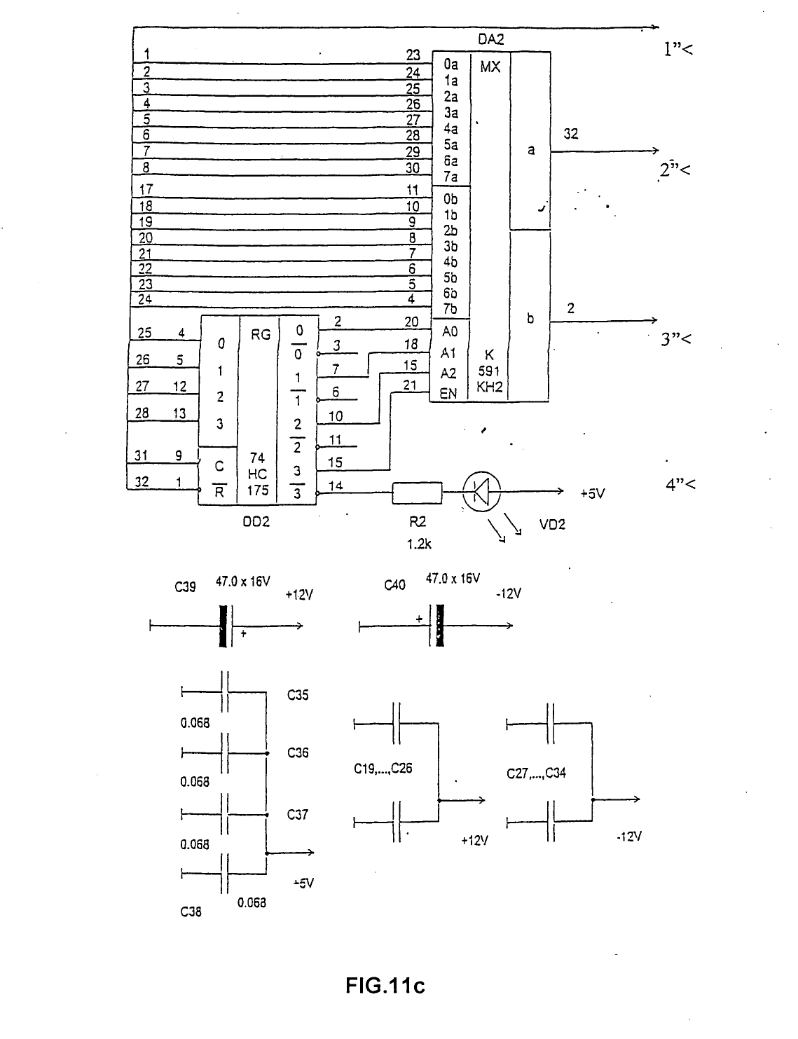

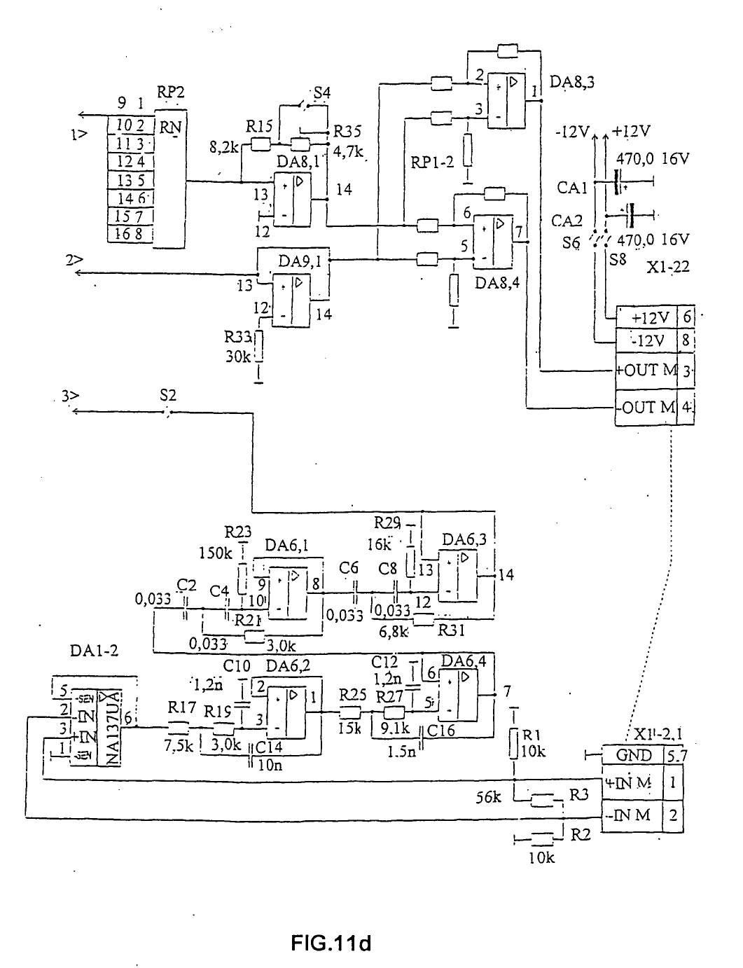

In particular, operation of a user circuit board according to FIGS. 11a, 11b, 11c, 11d is as follows.

Functionally, a user circuit board consists of two devices-user cells disposed on one circuit board, which board is an integral module coupled to the remaining portion of the circuit via PLD-type couplers (connector X1). Each device provides operation of one “user”, or, in other words, an audio channel. Each of the devices operates basing on the identical principle.

A first audio channel comprises microcircuits DD1, DA1, DA1-1, DA5, DA7, DA9.2; sets of resistors RP1, RP1-1; resistors R1, R14, R16, R18, R20, R22, R24, R26, R28, R30, R32, R34, R1-1, R2-1, R3-1; capacitors: C1, C3, C5, C7, C9, C11, C13, C15; light-emitting diode VD1 and connectors X1-1.

A second audio channel comprises the following microcircuits: DD2, DA2, DA1-2, DA6, DA8, DA9.1; resistor sets RP2, RP1-2; resistors R2, R15, R17, R19, R21, R23, R25, R27, R29, R31, R33, R35, R1-2, R2-2, R3-2; capacitors C1, C3, C5, C7, C9, C11, C13, C15; light-emitting diode VD2 and connectors X1-2.

Capacitors C19-C40 are the blocking ones and provided in the power supply circuits of said microcircuits.

The optionally included element is the circuit that provides operation of speakers, comprising elements DA9.3, DA9.4, X2, X3, as well as the power “reception” circuit for +12V and −12V, which circuit is connected via contacts of connector X1-2 from “tutor's/supplying LINGO-CARD”: S6, S8, C41, C42.

Operation principle of said circuit is exemplified by operation of the 1^{st} channel.

The audio signal from a user, transmitted in the differential mode through the twisted pair from the audio card main line transmission channel, enters—via connector X1-1.1 (“+IN_M” and “−IN_M”)—the differential-mode signal receiver of a given cell. The receiver circuit is implemented using microcircuit DA1-1 and resistors R1-1, R2-1, R3-1. The single-phase signal is picked off the output of differential receiver DA1-1(6), and further is passed via a bandpass filter that passes acoustic vibrations within the range of 220 Hz to 11000 Hz.

The bandpass filter consists of the in-series elements: Chebyshev low-pass filter (LPF) of the 4^{th} order, and Butterworth high-pass filter (HPF) of the 4^{th} order.

The LPF is implemented basing on the following elements: DA5.2, DA5.4, R16, R18, R24, R26, C9, C11, C13, C15.

The HPF is implemented basing on the following elements: DA5.1, DA5.3, R20, R22, R28, R30, C1, C3, C5, C7.

The “filtered” audio signal is supplied to one half of dual 8-channel multiplexer based on microcircuit DA1. Via said multiplexer, according to a pre-determined combination of control signals FN0, FN1, FN2, EN, LOAD/a, said audio signal is switched to one of contacts OUT0/a, OUT1/a . . . OUT7/a. Said switching is ensured by co-operation of microcircuits DD1 and DA1. Light indication, performed by elements R1, VD1, allows to register the moment when the control command for doing a predetermined switching has come.

The control signals—via the bus having connector X1—are generated by the mother board control circuit that transforms the RINEL-LINGO computer programme control codes through serial port COM 1/2.

Thus, the foregoing specification describes operation of a user cell for reception of the differential-mode signal picked off the main line—twisted pair. Below follows description of operation of the circuit for transmitting the single-phase audio signals through a differential driver into the main line by another twisted pair.

The audio signal, via one of the software-predetermined conductors IN0/a,b . . . IN/a,b is delivered, via the mother board signaling bus, to a corresponding input of the second half of the multiplexer that “services” operation of another user cell audio channel. The differential-mode audio signal, received from the audio card, having passed the differential receiver and bandpass filter and being in the normal single-phase form, arrives at one of the RINEL-LINGO software-predetermined conductors of the mother board signaling bus (OUT0/a . . . OUT7/a in a user cell), and further—via connector X1—is supplied to circuits designated by the following numbers: IN0/a,b, IN1/a,b . . . IN7/a,b. Each of said conductors can be provided with the single-phase audio signal that comes through a corresponding circuit of reception of the differential-mode signal of each one of particular user cells. This signal is the sum of the single-phase audio signals coming from the analog summers arranged in the mother board. Each summer is able to add as much as 16 audio signals. When 16 users are combined, 8 different audio groups can be obtained. All 16 users hear one another, i.e. there is a common sound field, or only a pair of users hear one another, and only 8 such pairs can be formed. This is the reason that the second input of the dual 8-channel multiplexer receives 8 signals designated on the diagram as IN0/a,b . . . IN7/a,b. According to a pre-determined combination (DD1, DA1) of audio signals switching, the obtained “mix”, having passed through buffer amplifier DA7.1, is supplied to one of inputs of the differential-mode signal (so called “differential driver”), which receiver is based on the following elements: DA7.3, DA7.4, PR1-1. The “own” signal (supplied to input DA1(2)), that is present at output DA1(32) and incorporated in the “mix” with other audio signals, having passed buffer amplifier DA9.2, enters another input of the differential-mode signal receiver. Further, said signal —via connector X1-1 and the contacts designated in the diagram as “+OUT_M” and “−OUT_M”—being already in the form of the differential-mode signal, enters the audio card reception channel through the (“main”) line. Connector X1-1 (similarly to X1-2) is a socket positioned on a printed circuit board, for connecting the standard 8-contact plug RJ-45, which is extensively used for mounting of twisted pairs. It apparently follows from the diagram that one twisted pair (“+IN_M ” and “−IN_M”) is used for transmitting the audio differential-mode signal from the audio card to the user cell input. For transmission of the “mixed signal”, i.e. the sum of signals from other users, added in the mother board, another twisted pair is used (“+OUT_M” and “−OUT_M”). Two other pairs remain inactivated (except for the case when these inactivated pairs—in a certain combination of jumpers on the mother board, audio card and subscriber board—are used for transmitting the supply voltage +12V and −12V picked off the computer mother board connector, in which board a corresponding audio card is inserted (otherwise termed as the “tutor's card” or “supplying card”).

Trimmer resistor R34, positioned in feedback circuit DA7.1, serves to compensate any parameter variance of the resistors comprised by resistor assembly RP1 for “zeroing” the “own” signal in the course of tuning of the subscriber circuit board. As follows from the diagram, the “own” signal “S” comes through the circuit from DA1(2) input via one of conductors OUT0/a-OUT7/a at one of resistors PR1, and further—to “compensating” buffer amplifier DA7.1 and to one input of differential driver DA7.3(2) and DA7.4(5). The “mix of signals” , wherein “S” signal is also present, is supplied—via DA1(32) and buffer amplifier DA9.2—to another input of the differential driver. Further, at output of differential driver DA7.3(1), the “own” signal is present with “+S” sign, and at the second output of the same differential driver—with “−S” sign. The noises that penetrate from other subscribers when being switched to inputs of the differential-mode signal receiver, will be also present in their straight and inverted forms. Thus, the “own” signal that arrives at the user cell input will be compensated. Only the “mix” of audio signals from other users, that were switched by the command given by RINEL-LINGO programme, “returns” into the user's (main) line.

Buffer amplifiers DA9.3 and DA9.4 serve for transmitting the audio signals'“mix” in the analogue form through connectors X2 and X3 to the active or passive speakers of the loudspeaker communication. As seen in the block diagram, up to two pairs of speakers can be connected to output of each one of amplifiers DA9.3(8) and DA9.4(7).

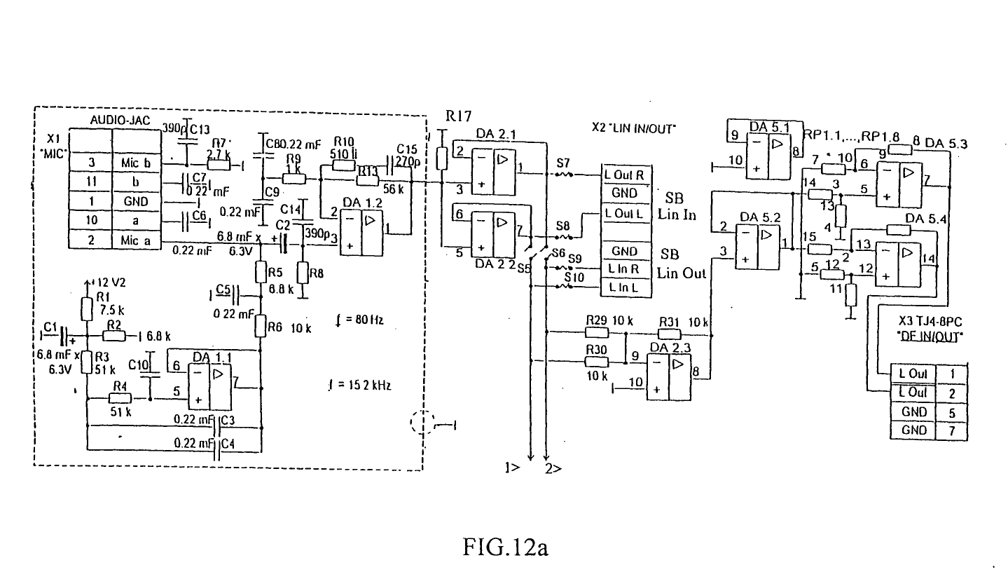

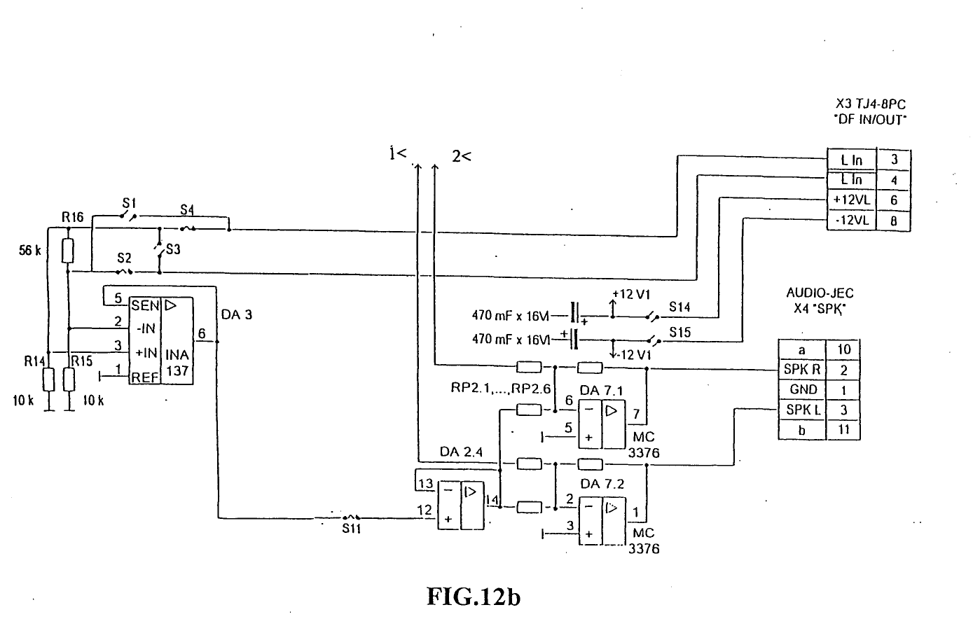

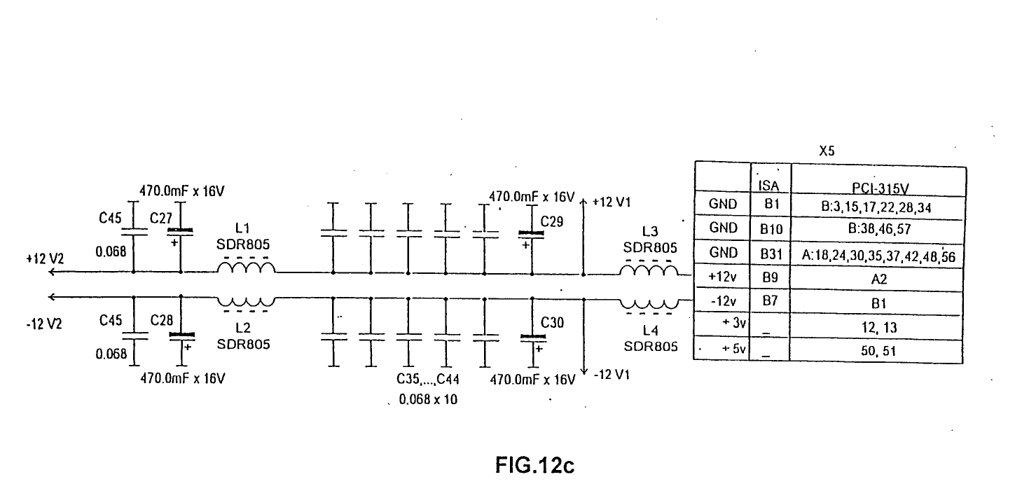

Description of operation of an audio card (LINGO-card) according to the block diagram shown in FIG. 12a, 12b, 12c is provided below.

Functionally, the audio card consists of four devices arranged in a single printed-circuit board, which board is built in connector PCI or ISA of a computer circuit (connector X5).

The audio card provides operation of one “user” , or, in other words, an audio channel that connects a computer user to a user cell disposed in a user circuit. The main function of the audio card is to “mix the audio signals” coming from the user microphone with the audio signals generated by the audio computer circuit board having the audio card connected thereto; to convert the obtained “mix” from the single-phase form into the differential form, to be transmitted along one main line (a twisted pair) to a user cell; as well as for receiving the audio differential-mode signal coming from a user cell along another twisted pair for converting said signal into the electrically single-phase type of the acoustic vibration.

The audio card comprises, in particular, a microphone amplifier that includes microcircuits DA1.1, DA1.2; DA2.1, DA2.2; resistors R1-R10, R13, R17; capacitors C1, C3-C9, C13-C15; connectors: X1 “MIC”, X2 (Lin Out R”, “Lin Out L”).

The audio card also comprises a dual buffer amplifier that includes microcircuits DA7.1, DA7.2, DA2.4; sets of resistors RP2; connectors X4 “SRK”, X2 (“Line In R”, “Line In L”).

The audio card also comprises a differential-mode signal receiver that includes microcircuits DA3; resistors R14-R16; connectors X3 (“+Line In M”, “−Line In M”).

Further, the audio card comprises a differential-mode signal transmitter (otherwise termed as “differential driver”) that includes microcircuits DA2.3, DA5.2, DA5.3, DA5.4; a set of resistors RP1; resistors R29-R31; connectors X3 (“+Line Out M”, “−Line Out M”).

Capacitors C27-C30, C35-C46 are the blocking ones and provided in the power supply circuits of considered microcircuits. For suppressing the pulse interferences that penetrate along the power supply circuits through connector X5, used are chokes L1 . . . L4.

An additional (optionally connected element) is a circuit that transmits the supply voltage “+12V” and “−12V” delivered through connector X5 via closed jumpers S14, S15 along a main line (two twisted pairs). Non-used element DA5.1 has feedback loop DA5.1(8)-DA5.1(9) to reduce the power consumption and possible pulse interferences that affect operation of the circuit's remaining portion.

The microphone amplifier operates as follows.

An electret microphone is connected to contacts of connector X1. Operation of a microphone of such type requires the constant shift of the current that flows therethrough. This shift is provided by a DC generator implemented in microcircuit DA1.1. As a result of conversion of the acoustic vibrations into the electric ones by a microphone, the signal from contact of connector X1(2) arrives at input of bandpass filter via stopping capacitor C2. Bandwidth of the bandpass filter implemented in microcircuit DA1.2 is 80 Hz to 15200 Hz. Further, to provide for the “pseudo-stereo” mode of operation of the microphone, the filtered signal arrives at the common input of buffer amplifiers DA2.1, DA2.2, and further; and two identical signals from two outputs DA2.1(1), DA2.2(7), via connector X2 (“Lin Out R”, “Lin Out L”), are supplied to the linear input of the audio circuit board (this connection is provided by the white stereophonic audio cable, having standard 3.5 mm plug at one end, and a rigid soldered connection on LC). For further suppression of the noises that penetrate from the microphone input, the circuit board is arranged to have the additional shielding for all elements of the microphone amplifier—denoted in the diagram by the broken line.

The electric acoustic vibrations generated by a microphone, via a group of jumpers S5, S6, S7, S8, S9, S10, when they are organized in a certain combination, can arrive directly at input of the dual buffer amplifier (DA7.2(2), DA7.1(6)), which amplifier provides operation of headphones (or active/passive speakers connected to connector X4), as well as at input of the summer of the audio signals (of the “left” and “right” channels) DA2.3 (from said summer, said vibrations can be supplied to the common input of differential driver DA5.2(3), and further—into the main line to the input channel of the user board connected LC). In such combination of jumpers S5 . . . S10, LC may not use the audio computer circuit board at all, but “mix” and transmit/receive both its own microphone signals and the other users'microphone signals.

Jumpers S5-S10 being in the “normal” position, LC will “receive” the acoustic vibrations coming from the audio computer circuit board linear output to connector X2 (“Line In R”, “Line In L”) (this connection is provided by the black stereophonic audio cable having standard 3.5 mm stereo plug at one end and the rigid soldered connection at LC). Acoustic vibrations from the left and right channels of the computer audio circuit board come concurrently at the differential driver summer input and at inputs of the left and right channels of the dual buffer amplifier.

The dual buffer amplifier operates as follows.

The amplifier consists of two identical analogue summers, each of which services its “own” audio channel, DA7.1—the left channel, DA7.2—the right channel. Microcircuit DA2.4 implements a buffer amplifier that matches output of the differential-mode signal receiver (DA3(6) with inputs DA7.1(6) and DA7.2(2). The acoustic vibrations coming from the computer audio circuit board linear output can be heard in the stereo mode, and the signals coming along the main line from other users are heard in the mono mode. Thus, summer of the left channel DA7.1 provides “mixing” of the computer circuit board left channel signals with the “mix” of audio signals from other users, out-coming from a user cell. The summer of the right channel DA7.2 also performs “mixing” of the same signals from other users, but only with the audio circuit right channel signal. The so amplified and “mixed” audio signals are supplied through connector X4 to headphones or active/passive speakers of the left and right channels (X4(“SPK R”, “SPK L”, respectively).

The differential-mode signal receiver operates as follows.

The “mix” of the other users'acoustic vibrations, that comes from a user cell, arrives—via the contacts numbered as X3 (“+Line In M”) and X3 (“−Line In M”)—at input of differential-mode signal receiver DA3. The standard analogue audio signal coming, as mentioned above, to input of buffer amplifier DA2.4(12) is picked off the output of receiver DA3(6).

A differential driver operates as follows.

Audio signals of the left and right channels of the computer audio circuit board are delivered, at first, to input of analogue summer DA2.3. In such summation, the stereophonic signal is transformed into the monophonic one, and, moreover, the acoustic vibration amplitude is doubled. The doubled monophonic signal thus obtained is supplied to the differential driver input, and from outputs of microcircuit DA5.3(7) and DA5.4(14) the differential-mode signal—via contacts of connector X3 (“+Lin Out M”) and X3(“−Lin Out M”)−is transmitted to the main line in the user cell input channel. The differential-mode signal receiver implemented on the basis of microcircuit BB INA137, or its analogue AD SSM2143, comprises the built-in divider in-two. Thus, the differential-mode signal transmitted through the main line and passed through the differential mode signal receiver, arrives at a user cell with the same amplitude as it had in the left and right channels of summer DA2.3.

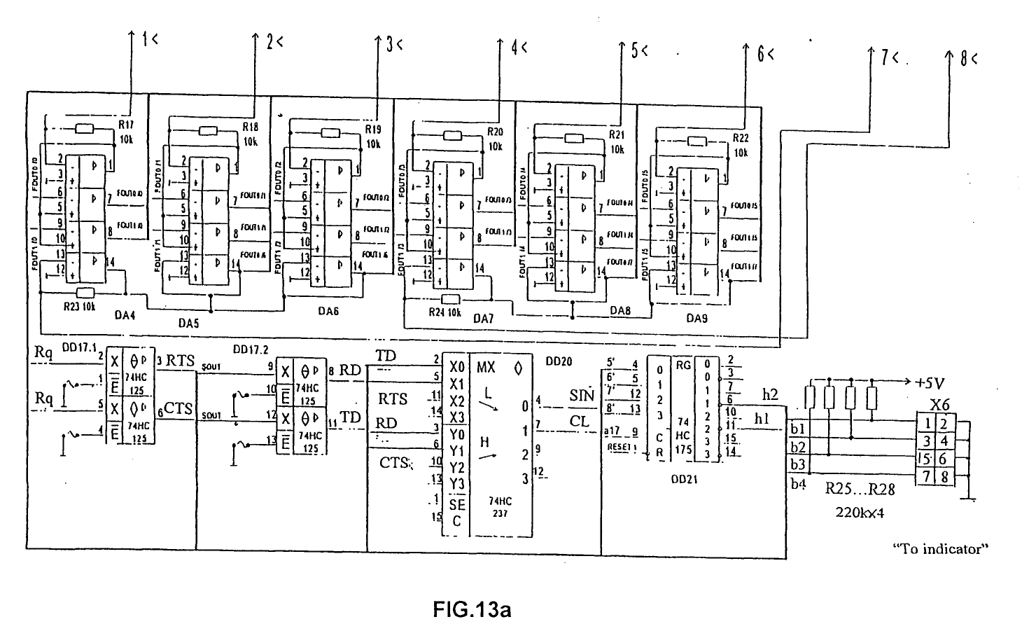

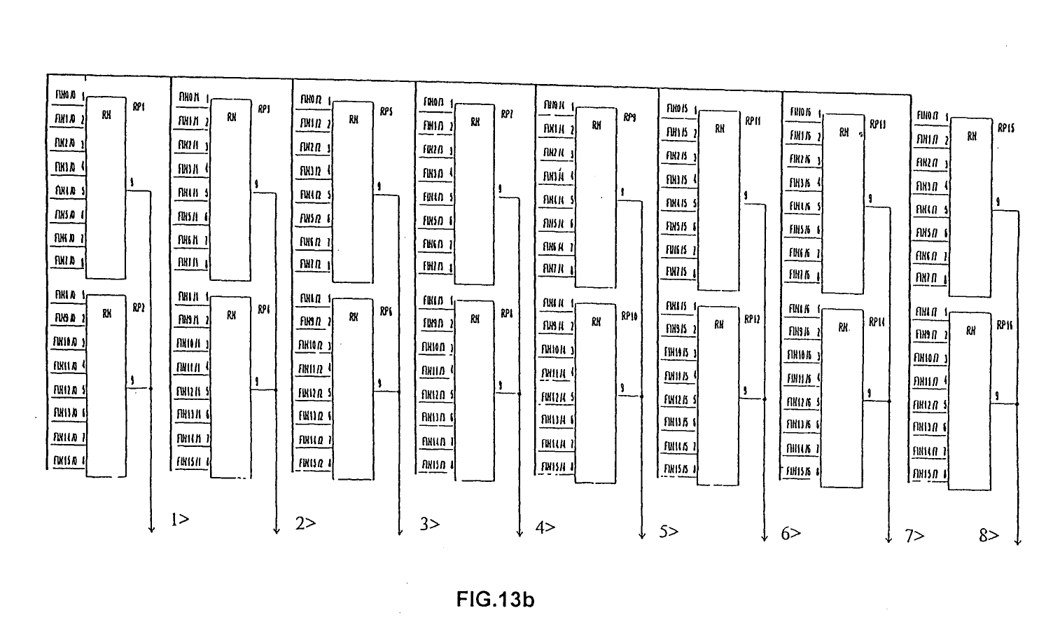

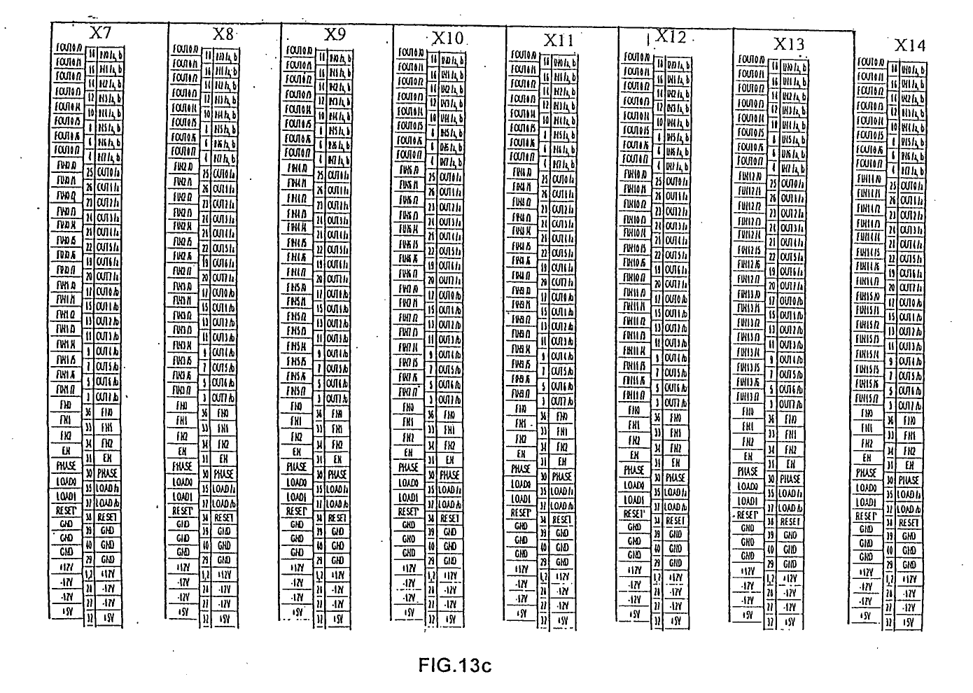

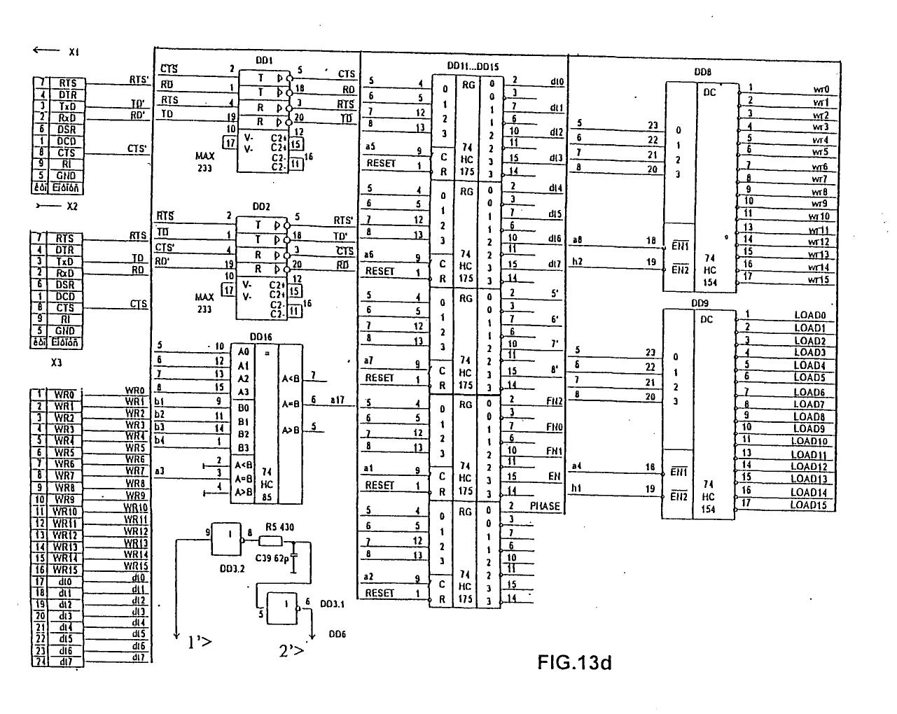

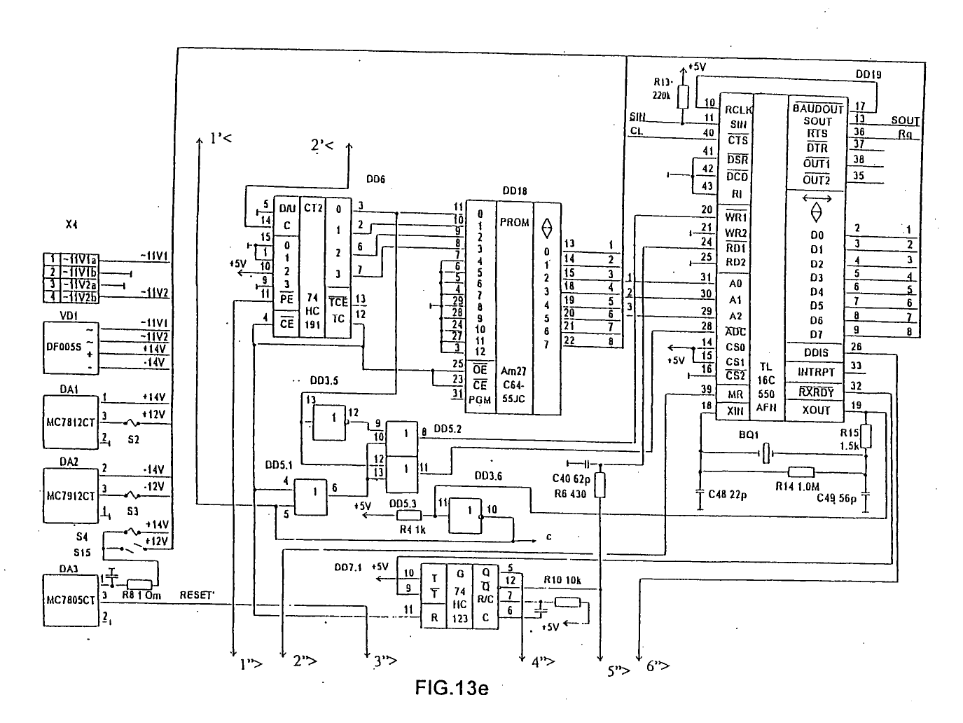

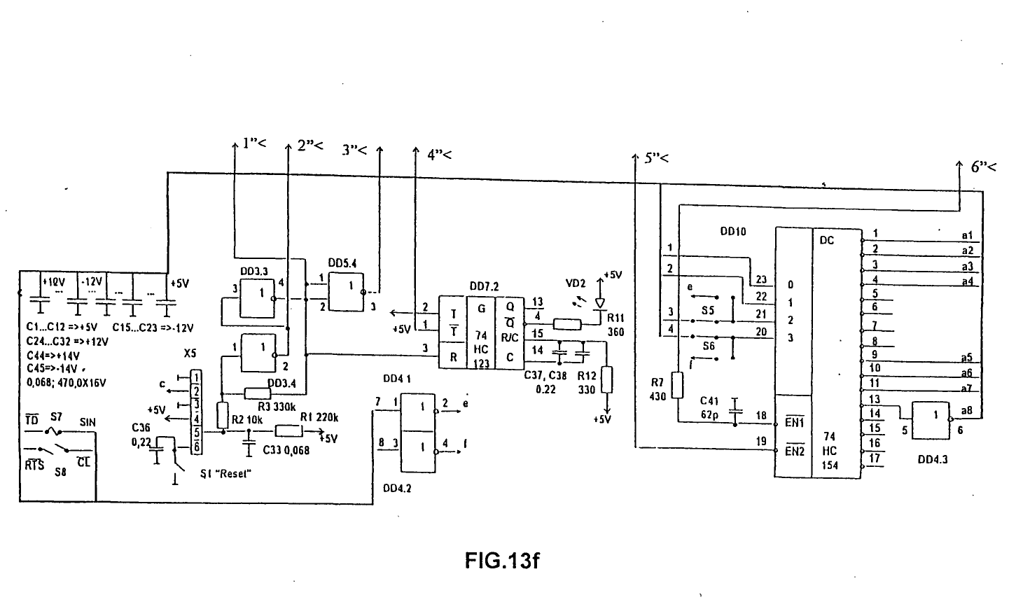

Below description of operation of the mother board according to the block diagram shown in FIGS. 13a, 13b, 13c, 13d, 13e, 13f is set forth.

Functionally, the mother board consists of four devices disposed on a single printed-circuit board enclosed in a housing. The printed-circuit board has PLD-type connectors, to which connectors the modules—user circuits (connectors X7-X14) are connected.

The unoccupied portion of the printed-circuit board also accommodates a device for controlling the audio signals switching; a device for converting the supply voltage, and 24 summers of analog audio signals, which are associated in a certain order in a so called device for sound fields switching.

The mother board (hereinafter “MB”) includes a switching device, control device, sound fields switching device and power supply control device.

The switching device comprises connectors X7-X14.

The control device comprises quartz resonator BQ1, microcircuits DD1-DD19, resistors, capacitors, light-emitting diode VD1 and connectors X1-X3.

The sound fields switching device includes microcircuits DA4-DA9, resistor assemblies RP1-RP16; resistors 17-R22.

The power-supply control device includes diode bridge VD1, voltage regulators DA1-DA3, resistors R1, R3, R8; capacitors C1-C12, C15-C33, C44, C45 and connectors X4, X5.

MB provides operation of the whole complex, it coordinates and controls cooperation of the user circuit boards and audio cards connected to MB. According to the commands—arriving via connector X2 and specified by RINEL-LINGO software—MB allows to perform switching of the electric acoustic vibrations, “intermixing” them in the programmed combinations.

The control device operates as follows.

RINEL-LINGO software generates the control codes that are supplied from a computer via connector COM 1/2 to input LP—connector X2. The codes are transmitted at the rate of 9600 bauds (bit/s) according to standard protocol RS-232. Transmission rates of code data are matched, and decoding of the codes is provided by cooperation of clock (BQ1, R15, C48, C49), asynchronous commutator (DD19), signal transceiver according to protocol RS-232 (DD1) and read-only memory (ROM)—DD18 that stores pre-written decoding codes. When the codes arrive at contact X2 (“TD/RD”), these signals are processed in DD1 and transmitted to DD19 and DD18 via a set of decrypters DD6, DD3, DD11-DD13. Microcircuit DD2 transmits the computer codes arrived at X2 to other identical unit in MB via connector X1, wherein the control codes are processed similarly to the foregoing. A position of jumpers in connector X5 determines a unit address, i.e. determined is a particular MB whereto the control codes have been transmitted. The fact that the program codes have transmitted (an appropriate signal has appeared in connector X1) is shown when light indicator VD2 is activated. Comparator-microcircuit DD16 determines appurtenance of the codes to a particular MB. Thus, when codes are assigned to a particular MB, the above-mentioned microcircuits cooperatively generate the following control signals: LOAD0-LOAD15, FN0, FN1, FN2, PHASE, a1-a8, a17 that are used to switch the acoustic electric signals in a predetermined combination in the sound fields switching device. Connector X3 is provided for transmission of additional control signals (WR0-WR15, DT0-DT7) to a so called “MB extension unit (LINGO-unit)”, which is an additional controlling device allowing to enhance capabilities of said MB for further evolution and possible modification of an existing MB model. Decrypters DD8, DD10, together with registers DD11-DD13, allow cooperation of said MB with a “MB extension”.

A switching device consists of a group of PLD-type connectors (X7-X14), through which connectors the user cells are connected. Connectors X7-X14 are interconnected according to the parallel connection scheme—a bus structure. As regards functionality of the signals existing on the connectors, the following four their groups can be classified: power supply bus—“GND”, “+12V”, “−12V”, “+5V”; control bus—“LOAD0”-“LOAD15”, “FN0”-“FN2”, “EN”, “PHASE”, “RESET”; incoming audio signal bus—“OUT0/a-“OUT7/a”, “OUT/b”-“OUT7/b”; outcoming audio signal bus—“INO/a, b”-“IN7/a, b”.

The audio signals from the user cells arrive at the incoming audio signal bus, and along said bus they are supplied to inputs of the sound fields switching device. Further, in accordance with the control bus signals generated by the control device, the selected combination of sums of the audio signals is supplied from outputs of the sound fields switching device to the outcoming audio signal bus, and then—to the predetermined (selected according to a control bus signal combination) user cells.

The sound fields switching device consists of 8 separate analog summers, each of which is adapted to have up to 16 input signals at its input. For the 16-user combination, 8 different audio groups can organized. That is, all 16 users hear one another, so that the single sound field exists, or the users hear one another in pairs, and the maximum number of these sound fields will be 8. Thus, the outcoming sound signal bus has only 8 conductors, as distinct from the incoming audio signals bus that has 16 conductors.

All required supply voltages for operation of all active elements provided for in the printed-circuit boards (up to 8 user circuit boards connected via connectors X7-X14 to MB and via the active elements in MB itself) are applied by a power supply voltage conversion device.

Jumpers S2, S3, S4, S15 in the MB being in a certain combination (and other jumpers in LC and a user circuit—cf. the description of operation according to the block diagrams), the power supply voltage delivery can be effected in two methods.

According to the first method, alternating voltage is delivered via connector X4 (for example, the voltage can be picked off two secondary transformer windings, wherein the primary winding is coupled to mains of 220V), and via rectifying diode bridge VD1 the rectified and filtered voltage is applied to regulators DA1, DA2, DA3 to obtain a set of supply voltages of “+12V”, “−12V”, “+5V”, respectively.

According to the second method, voltages of “+12V” and “−12V” picked off the computer mother board provided with “dedicated LC”—via connector X7—are applied to a “dedicated user circuit board” along the main line. A user circuit board is termed so for the reason that owing to a combination of the jumpers disposed therein, said pair of the supply voltages passes through connector X7 to the power supply bus. In such method for applying the power supply voltage, regulators DA1, DA2 remain inactive. It is only regulator DA3, providing the power supply voltage of “+5V” from that of “+12V” received from the power supply bus, that becomes activated.

Industrial Applicability

The invention has been embodied in an apparatus under trade name of “A multimedia linguaphonic set RINEL-LINGO AUDIO” that comprises audio commutator RINEL-LINGO AUDIO and audio cards RINEL-LINGO; and also in an apparatus under the trade name of “Multimedia linguaphonic set RINEL-LINGO VIDEO” that comprises video commutator RINEL-LINGO VIDEO and video cards RINEL-LINGO. The arrangement includes RINEL-LINGO software developed by RINEL company to control the whole arrangement.

1. (canceled)

2. An audio-video communication apparatus for computer users, comprising
a tutor's central computer having a software for arranging for an educational process, and learners'computers connected thereto via communication channels;
characterized in that said apparatus comprises:
at least two audio cards, to each of which cards connected are a microphone and headphones of the computer users; and
at least two video cards;
each one of the audio and video cards being inserted in ICA-, or PCI-slots in each one of the computers;
at least one video commutator and at least one audio commutator that establish the audio and video communication among the computer users;
the learners'computers and the tutor's central computer being connected via the audio and video cards, respectively, to the audio commutator and video commutator; and
the central computer—via a control channel, using control cables—being connected to the audio commutator, and—via the audio commutator—to the video commutator; and
said central computer, using an appropriate software, controls the formation and transformation of learners'groups, and the switching of the sound from the individual communication to the common loudspeaker communication;
whereas the audio and video signals are transmitted by hardware means without use of the hard- and software resources of
